(19) United States
(12) Patent Application Publication
(10) Pub. No.: US 2010/0318385 A1
(43) Pub. Date: Dec. 16, 2010

(54) METHOD AND SYSTEM FOR ASSIGNING SEATS ON BOARD COLLECTIVE MEANS OF TRANSPORT

(75) Inventors: Edoardo Serra, Torino (IT); Sergio Mello, Moncalieri (Torino) (IT); Stefania Andresciani, Torino (IT)

Correspondence Address: HESLIN ROTHENBERG FARLEY & MESITI PC, 5 COLUMBIA CIRCLE, ALBANY, NY, 12203, US

(73) Assignee: WEBRAINSTORM S.R.L., Torino (IT)

(21) Appl. No.: 12/744,090

(22) PCT Filed: Nov. 20, 2008
(86) PCT No.: PCT/IB08/03250

§ 371 Date: Aug. 20, 2010

(30) Foreign Application Priority Data
Nov. 23, 2007 (IT) TO2007A000844

(51) Int. Cl. G06Q 10/00

(52) U.S. Cl. 705/5

(57) ABSTRACT

A method for assigning seats on board a collective means of transport, for example an aircraft belonging to a airline company, includes the step of providing a data bank accessible to the transport company and containing the demographic data of the passengers, accompanied by personal profiles deriving from information supplied by the passengers themselves and indicating their personality, interests, and preferences. The personal profiles, possibly integrated with further contingent information supplied by each passenger in relation to specific needs or wishes correlated to the booking, are processed to determine mutual compatibility of the passengers booked on the same means of transport. The seats on board the means of transport are then assigned according to the mutual compatibility of the passengers thus determined.

### FIELD OF THE INVENTION

The present invention relates in general to collective means of transport, such as aircraft, trains, buses, ferries and boats in general, provided by transport companies, and regards more in particular a method and a system for assigning seats on board said means of transport.

Even though the ensuing description refers expressly to the case of aircraft belonging to airline companies, all the considerations, problems and purposes of the invention regarding them are applicable in a practically identical way also to the other collective means of transport by land and by sea referred to above.

### BACKGROUND OF THE INVENTION

The modern way of life leads people, for personal or professional reasons, to travel long distances with increasing frequency, using transport companies.

In the specific case of airline companies, in recent times and particularly after the 11th of September 2001, the operations of embarkation on board flights have become increasingly complicated and stressful for passengers on account of invasive and extenuating checks carried out for reasons of safety.

The airline companies are, on the other hand, continuously seeking new tools for favouring customer loyalty and for providing a user profile that might prove useful for meeting market needs and the direct sale of products (creation of alliances between airlines), there being at the same time ever-increasing sensitivity on the part of the airline companies to the question of fixed costs, which can often be cut through re-sizing of the services provided on board (as is the case of traditional airlines) or through an unbundling of additional services from the value of the stretch, rendering them optional (as is the case of the so-called “low cost” airlines.

There is hence the need to make tools available that will enable improvement of the service rendered by the airline company (and more in general by transport companies as a whole) to their customers, without, however, affecting appreciably the costs sustained by the transport company.

A further need, which is also aimed at a reduction of the general running costs of the transport company, consists in the use of high-capacity and long-range aircraft (and collective means of transport in general), which, however, are very trying for a large number of passengers both on account of the high density of travellers on board and on account of the longer duration of journeys without breaks or intermediate stops.

It would hence be desirable to make available a tool that will improve the relationship between the transport company and the customer through a process of mutual benefits that will enable an enrichment of the service to the advantage of the customer and will at the same time be economically advantageous for the transport company.

### SUMMARY OF THE INVENTION

In consideration of the foregoing, the primary object of the present invention is to qualify the time spent by the passengers on board the collective means of transport, specifically an aircraft, implementing a “customer-oriented” policy through an enhancement of the so-called “customer-relationship management” (CRM), based upon a greater interaction of the airline company with the customer and between the customers of the company.

More in particular, the object of the invention is to provide a method and a system for assigning seats on board an aircraft belonging to an airline company, and more in general on board a collective means of transport provided by a transport company, which is based upon psychological profiles of the passengers and on the preferences expressed at the time of sale of the tickets or at check-in, with effects that are advantageous both for the end user (passenger) and for the transport company that provides the service.

The methods and systems for assigning seats on board aircraft are currently based only upon sales logic and proper distribution of the load, irrespective of the affinity of character, similarities of personal profiles, flight preferences and contingent wishes of the passengers. The specific object of the invention is thus to make available a method and a system for assigning seats that will, instead, take into account the aspects referred to above.

With a view to achieving said object, according to a first aspect, the invention envisages a method for assigning seats on board a collective means of transport, typically an aircraft, basically characterized in that it comprises the following steps:
providing a data bank accessible to the transport company and containing the demographic data of the passengers that use said transport company, accompanied by personal profiles deriving from information supplied by the passengers themselves and indicating their personality, interests, and preferences;
processing, upon booking, the aforesaid personal profiles for determining mutual compatibility of the passengers booked on the collective means of transport; and
assigning the seats on board said means of transport according to the compatibility of the passengers thus determined.

The assignment of the seats can envisage the closeness between mutually compatible passengers, or, alternatively, separation between mutually incompatible passengers.

According to the invention, there may moreover be envisaged the further step, upon booking or at check-in, of integrating the personal profiles of the passengers with further contingent information supplied by each passenger in relation to specific needs or wishes correlated to the booking, and of accordingly reprocessing the mutual compatibility of the passengers for hence re-assigning the seats on board the means of transport.

The method may moreover comprise the step of notifying to the passengers upon embarkation, via SMS or by means of a type of message that can be received on a mobile device made available to the passenger, information regarding the passenger or passengers assigned to the contiguous seat or seats.

The method according to the invention, which is based upon purposely devised “match-making” algorithms, enables appreciable advantageous effects to be achieved directly and indirectly both by the user (passenger) and by the transport company providing the service.

In the first case, the passenger is put in a condition to pass his or her time on board the means of transport more serenely and at his or her own ease, having consciously and directly chosen, apart from the physical position of the seat booked (window seat, aisle seat, seat far from children, etc.), the mode of travel: for example, sleeping, or else interacting with the person sitting alongside, or else reading, or again practising a specific language, etc. This makes it easier to pass the time of the journey, also and above all in the case of long stretches without breaks or intermediate stops.

In the second case, the introduction of the method for assigning seats enables the transport company to extend the data bank of its own customers both in terms of quantity and in terms of number of details of the personal profiles. The consequent economic spin-offs for the company result from the increase in efficiency of the marketing tools, which exploit the knowledge of the profiles of the customers for sales and promotion activities. The increased interaction between the transport company and the clientele can in fact constitute also an incentive to growth in terms of direct sales of air tickets via the Internet sites of the companies (a policy sustained and pursued by all airlines in view of the high costs of the booking commission applied by the intermediary agencies on indirect sales channels), with consequent reduction of the costs and hence considerable savings.

Undoubtedly, the Internet offers the most convenient and efficient interface both for the passengers that are to fill in the personal-profile questionnaire and for the manager's of transport companies (airline companies), who have to collect the data in a structured way. The end result is to offer the passenger a unique and fast solution for taking part in the program for assigning seats according to the invention and purchasing their tickets on-line.

Furthermore, the detailed profiling of the passengers on board is advantageous at the moment in which it accompanies the PNL (Passenger Name List) also for the purposes of safety, through a precise, spontaneous, and non-invasive control of the passengers.

Finally, the benefits in terms of improved capacity for rendering the journey more tolerable for the passengers means that transport companies can use means of transport, in particular aircraft, of increased capacity and longer range, also in this case, to the advantage of a reduction in management costs for the transport company.

A further subject of the invention is a system for implementation of the method defined above.

### BRIEF DESCRIPTION OF THE DRAWINGS

The invention will now be described in detail with reference to an embodiment thereof, which is provided purely by way of non-limiting example and is represented in the annexed drawings, wherein:

FIG. 1 is a flowchart that exemplifies the logic of the method for assigning seats according to the invention, with specific reference made to the case of an aircraft belonging to an airline company, during the step of booking of the flight by the passenger;

FIG. 2 is a flowchart similar to that of FIG. 1 regarding the check-in step;

FIG. 3 is a flowchart similar to those of FIGS. 1 and 2 regarding the embarkation step; and

FIG. 4 is a block diagram that summarizes the architecture of the system for assigning seats based upon the method according to the invention.

### DETAILED DESCRIPTION OF THE INVENTION

The method for assigning seats according to the invention is based upon the finding, in the specific case of an aircraft belonging to an airline company (which, however, can be extended also to any collective means of transport either on land or by sea), that the time of flight is in most cases used by the passengers for performing activities, such as reading, working, sleeping, listening to music, watching films, and chatting.

The first activities listed above are performed in complete autonomy and are hence independent of external interactions, whereas chatting is necessarily dialectical, and its quality basically depends upon the persons interacting in the conversation.

This is the key point of the method according to the invention: enabling the passenger to pass the time of the journey serenely and in a pleasant way both in the case where he or she does not intend to interact with the person next to him or her and in the case where he or she intends, instead, to socialize with another passenger, in the knowledge of sharing with the latter some interest or affinity. Starting from said assumptions, the method according to the invention uses a match-making software based upon permanent parameters integrated by information of a temporary or contingent nature, which each passenger supplies to a data bank, with which the transport company, in this case the airline company, is equipped.

The permanent parameters consist not only of the demographic data on the passengers that use the airline company, but also of personal profiles prevalently of a psychological nature (personality, interests, preferences, etc.), indicated obviously by the passengers themselves. The contingent information for integration of said permanent parameters regard, instead, specific needs or wishes correlated to the flight booked, such as for example the desired position of the seat (window seat or aisle seat) and the intention of interacting (chatting) or not (reading, sleeping, working, etc.) with the passenger or passengers sitting next to him or her.

Once the booking has been made, the data regarding the personal profiles are processed by the match-making software in such a way as to determine to a first approximation mutual compatibility or mutual incompatibility of the passengers booked on the same flight, and then proceed accordingly to a first assignment of seats on board the aircraft. Consequently, two contiguous seats will be assigned to two mutually compatible passengers, whereas mutually incompatible passengers will be kept separate.

The temporary parameters, i.e., the contingent information referred to previously, are supplied by each passenger at check-in. The match-making software then undergoes a re-processing, which leads to a possible consequent re-assignment of seats on board the aircraft.

Prior to embarkation or in the course of the flight, the seat assigned or re-assigned to each passenger and/or information regarding the passengers assigned to contiguous seats may be notified in a timely way, for example by the sending of an SMS to the corresponding cellphone, or by means of some type of message that can be received on a mobile device made available to the passenger.

With reference now in greater detail to the example of embodiment exemplified in the flowcharts appearing in the annexed drawings, the method according to the invention can be ideally divided into three successive steps: booking, check-in, and embarkation.

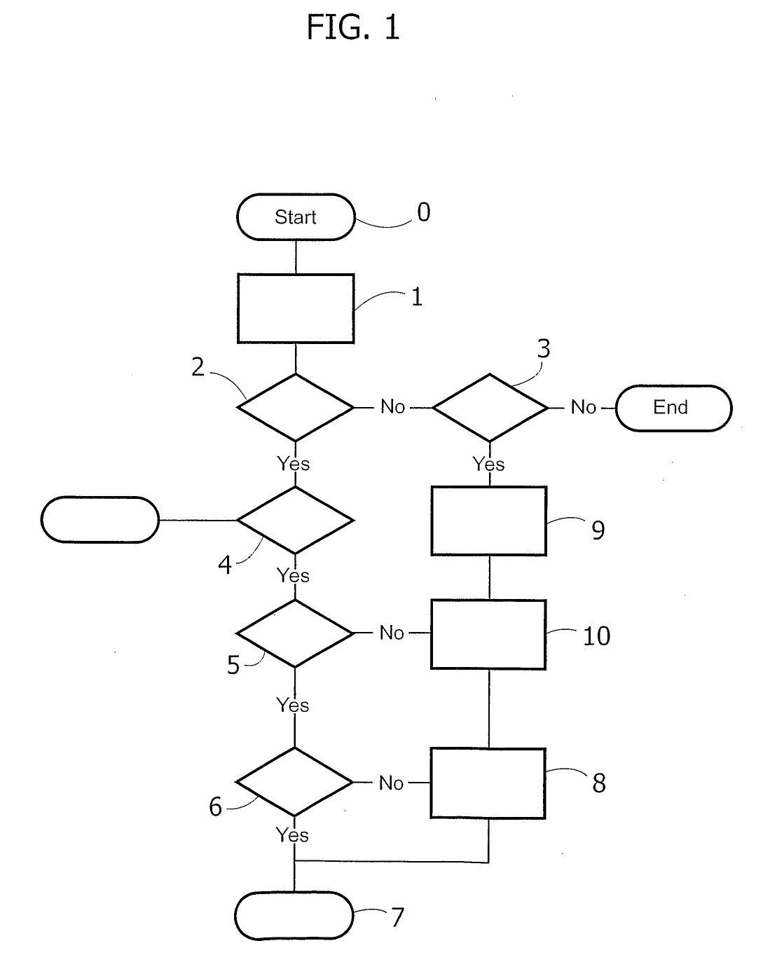

In the first step (represented in FIG. 1), the customer performs the booking of the flight, i.e., purchases the ticket at a travel agency or directly through the Internet site of the company (Block 0 of the flowchart). With this operation, the customer obviously supplies his or her own demographic data and the data regarding the flight chosen (Block 1) and is then invited to communicate whether he or she is or not registered in the FFP (Frequent Flyer Program), which practically all airline companies by now have available (Block 2 of the flowchart).

If the customer is registered, he or she will then supply also his or her own FFP identifier, which will enable the airline company to recognize and associate him or her to a personal profile already previously stored in its own data base.

If the customer is not registered, he or she will be invited to register in the FFP via the already existing channels, with the incentive deriving from the possibility of being assigned the seat via the method according to the invention, which in what follows will for brevity be referred to as VVS service. If the customer registers, he or she will be required to submit his or her own personal profile, providing information such as age, sex, profession, income, etc., as well as answering a questionnaire containing generic closed-answer questions (personality test).

In either case, the customer will then be asked whether he or she intends to use of the VVS service for assigning seats provided by the method according to the invention (Blocks 3 and 4 of the flowchart).

If the answer is YES and if the customer already takes part in the FFP, he or she will be asked whether he or she is already a user of the VVS service (Block 5 of the flowchart) and, if the answer is YES, will be asked to verify whether his or her own profile is updated (Block 6 of the flowchart). If it is, the transport company will proceed to registration of the booking with the VVS option (Block 7 of the flowchart).

If, instead, the customer were to discover that his or her own profile is not updated, he or she will proceed to updating it (Block 8 of the flowchart), which will then be followed by the registration of the booking, once again with the VVS option.

In the case where the customer is not yet registered in the FFP, after manifesting the intention to use the VVS service (Block 3 of the flowchart) he or she will be required to join the FFP (Block 9 of the flowchart) and hence also the VVS service (Block 10 of the flowchart), proceeding to filling in his or her own personal profile (Block 8 of the flowchart).

Also in this case, there will follow registration of the booking with the VVS option (Block 7).

At the end of the booking step, the airline company will thus have available in its own data bank a personal profile of the passenger including information indicating personality, interests, and preferences, which will subsequently be integrated with further temporary, i.e., contingent, information in the way clarified in what follows.

The data of the personal profiles thus available are then subjected to processing by the match-making software for a first optimal assignment of the seats to the passengers that have joined the VVS service.

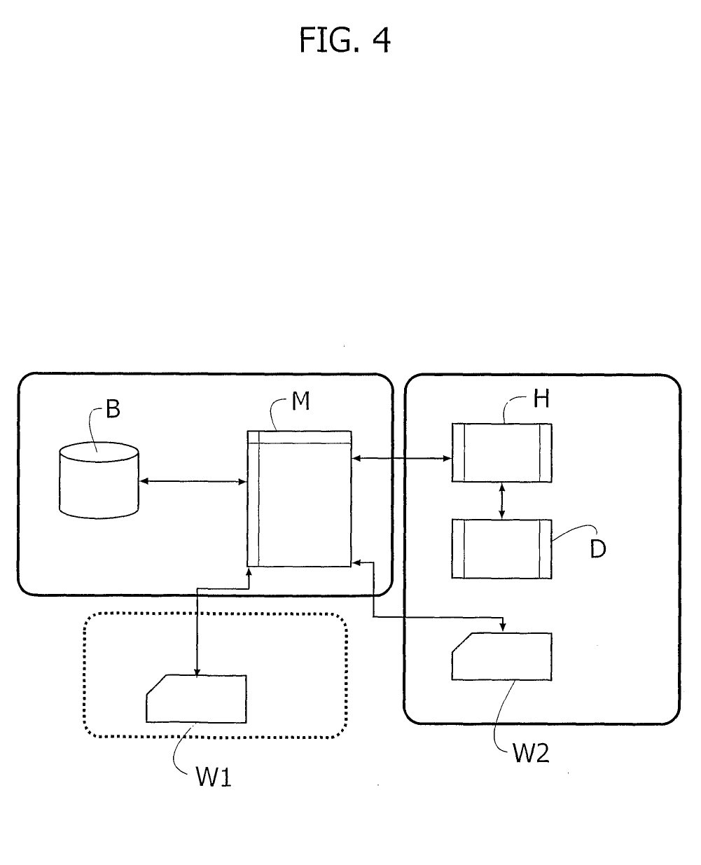

The diagram of FIG. 4 illustrates in brief, by way of example, the system for implementation of the seat-assigning method according to the invention.

It comprises a central processor H available to the airline company, operatively connected, in a known way, to a unit for control of the departures D, which is interfaced with the check-in desks of the company and operatively connected, for registration of the booking and assignment of the seats, to a processing unit M, which is in turn connected to the data bank B containing the personal profiles of the passengers. The processing unit M operates, as has been said, on the basis of a match-making software for determining, via successive approximations tending to maximize the results, mutual compatibility (or incompatibility) of the passengers booked on each flight, and for interacting with the central processor H in such a way that the assignment of the seats will be implemented thereby according to said compatibility (or incompatibility).

The processing unit M is interfaced both with the end users and with the airline company through telematic networks and Internet or TTY-message interfaces, designated by W1, W2.

In this way, at the end of the booking step, there will be provided for each flight a map for assigning seats on board, with which the passengers that have joined the VVS program and that are mutually compatible will be assigned to contiguous seats, whereas those who are mutually incompatible will be kept separate.

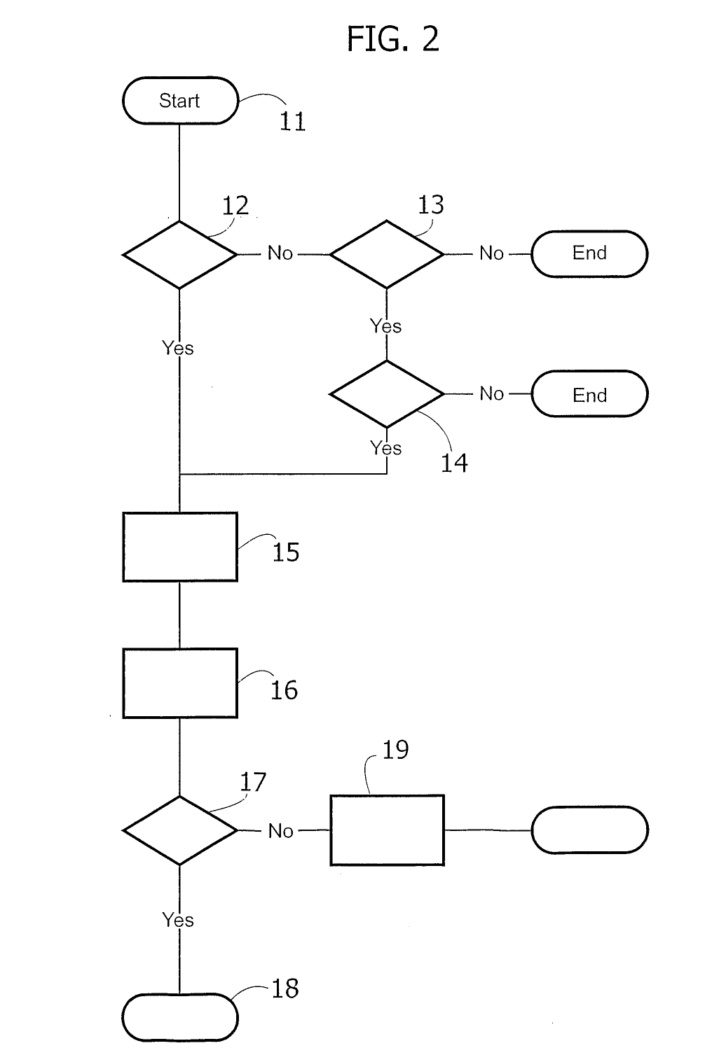

This map for assigning seats will then possibly be reprocessed, proceeding if necessary to the re-assignment of the seats, during the step of check-in in accordance with the flowchart represented in FIG. 2.

During said step (Block 11), after verifying whether, upon booking, the passenger at check-in has joined the VVS program or not (Block 12), or else whether said passenger is in any case a member of the VVS program (Block 13) and intends to use said program for the flight that is leaving (Block 14), the next step is to request the contingent information regarding specific needs or wishes of the passenger correlated to the flight that is leaving (Block 15). Said information can be supplied through an oral questionnaire (in the case of check-in with an operator) or else a telematic questionnaire (in the case of on-line check-in or at automated desks).

The seat assigned, once the booking has been made, is then confirmed, or else—taking into account any variations due to the possible contingent information supplied by the passenger—is re-assigned following upon a re-processing performed by the unit M of the system, and then proposed to the passenger (Block 16).

If the passenger accepts (Block 17), the embarkation card is printed (Block 18). If the passenger does not accept, he or she will be re-assigned a different seat (Block 19), irrespective of any possible compatibility or incompatibility with the other passengers.

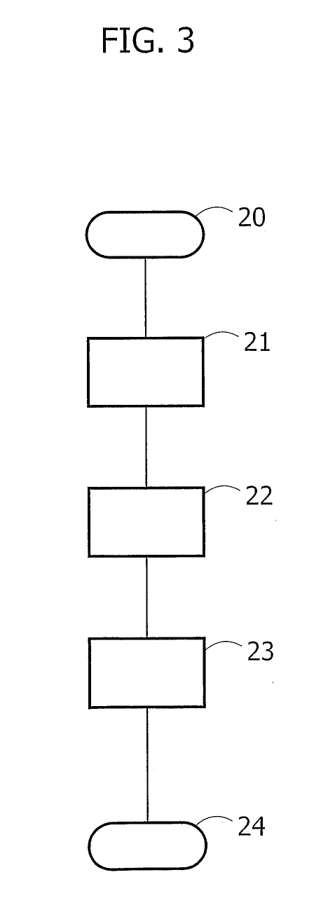

The flowchart of FIG. 3 illustrates the embarkation step: upon closure of the check-in stage (Block 20) and following upon the announcement of embarkation (Block 21), it is possible to envisage sending to the passengers (Block 22) SMS messages or any other type of message that can be received on a mobile device made available to each passenger, said messages containing summary information regarding peculiar characteristics, provided that said information can be expressly divulged, of the passenger or passengers assigned to the contiguous seat or seats. This will enable facilitation of the possibility of socializing of each passenger with the persons sitting next to him or her and increase the consequent degree of satisfaction.

At the end of embarkation (Block 23), the passengers that have joined the VVS program will be assigned seats in a condition where they will be able to interact and socialize more easily (Block 24).

Once the flight is over, each passenger may be contacted in modes chosen by themselves (electronic mail, ordinary mail, telefax, telephone) to provide

1. A method for assigning seats on board a collective means of transport belonging to a transport company, comprising:
providing a data bank accessible to the transport company and containing the demographic data of the passengers that use said transport company, accompanied by personal profiles deriving from information supplied by the passengers themselves and indicating personality, interests, and preferences of the passengers;
processing, upon booking, the personal profiles for determining mutual compatibility of the passengers booked on the same collective means of transport; and
assigning the seats on board said means of transport according to the compatibility of the passengers thus determined.

2. The method according to claim 1, wherein the step of assigning the seats envisages the closeness between mutually compatible passengers, or, alternatively, separation between mutually incompatible passengers.

3. The method according to claim 1 further comprising integrating said personal profiles upon booking or at check-in with further contingent information supplied by each passenger in relation to specific needs or wishes correlated to the booking, and of accordingly reprocessing said mutual compatibility of the passengers for then re-assigning the seats on board the means of transport.

4. The method according to claim 1 further comprising notifying the passenger upon embarkation, via a message that can be received on a mobile device made available to the passenger, information regarding the passenger or passengers assigned to the contiguous seat or seats.

5. The method according to claim 1 wherein the transport company provides a Frequent-Flyer-Program (FFP) service, and said data bank is correlated with said FFP service.

6. The method according to claim 1 further comprising contacting each passenger after completion of the journey to invite him or her to join an exclusive community so as to be able to keep in touch with the passengers with whom he or she has travelled.

7. A system for assigning seats on board a collective means of transport belonging to a transport company, the system comprising:
a data bank accessible to the transport company and containing the demographic data of the passengers that use said transport company, accompanied by personal profiles deriving from information supplied by the passengers themselves and indicating personality, interests, and preferences of the passengers;
means for integrating said personal profiles with further contingent information supplied by each passenger in relation to specific needs or wishes correlated to the booking;
means for processing the combined data of said personal profiles, integrated with said contingent information for determining mutual compatibility of the passengers departing on the same means of transport; and
means for assigning seats on said means of transport according to the compatibility of the passengers thus determined.

8. The system according to claim 7, further comprising means for notifying the passengers upon embarkation, via a message that can be received on a mobile device made available to each passenger, information regarding the passenger or passengers assigned to the contiguous seat or seats.

9. The method according to claim 2 further comprising integrating said personal profiles upon booking or at check-in with further contingent information supplied by each passenger in relation to specific needs or wishes correlated to the booking, and of accordingly reprocessing said mutual compatibility of the passengers for then re-assigning the seats on board the means of transport.

10. The method according to claim 2 further comprising notifying the passenger upon embarkation, via a message that can be received on a mobile device made available to the passenger, information regarding the passenger or passengers assigned to the contiguous seat or seats.

11. The method according to claim 3 further comprising notifying the passenger upon embarkation, via a message that can be received on a mobile device made available to the passenger, information regarding the passenger or passengers assigned to the contiguous seat or seats.

12. The method according to claim 2 wherein the transport company provides a Frequent-Flyer-Program (FFP) service, and said data bank is correlated with said FFP service.

13. The method according to claim 3 wherein the transport company provides a Frequent-Flyer-Program (FFP) service, and said data bank is correlated with said FFP service.

14. The method according to claim 4 wherein the transport company provides a Frequent-Flyer-Program (FFP) service, and said data bank is correlated with said FFP service.

15. The method according to claim 2 further comprising contacting each passenger after completion of the journey to invite him or her to join an exclusive community so as to be able to keep in touch with the passengers with whom he or she has travelled.

16. The method according to claim 3 further comprising contacting each passenger after completion of the journey to invite him or her to join an exclusive community so as to be able to keep in touch with the passengers with whom he or she has travelled.

17. The method according to claim 4 further comprising contacting each passenger after completion of the journey to invite him or her to join an exclusive community so as to be able to keep in touch with the passengers with whom he or she has travelled.

18. The method according to claim 5 further comprising contacting each passenger after completion of the journey to invite him or her to join an exclusive community so as to be able to keep in touch with the passengers with whom he or she has travelled.
